(19) United States
(12) Patent Application Publication
(10) Pub. No.: US 2023/0182447 A1
(43) Pub. Date: Jun. 15, 2023

(54) POLYMER FILM

(71) Applicant: CHANG CHUN PETROCHEMICAL CO., LTD., Taipei City (TW)

(72) Inventors: Yen-Chen Huang, Taipei City (TW); Tzu-Jung Huang, Taipei City (TW); Cheng Fan Wang, Taipei City (TW)

(21) Appl. No.: 17/853,598

(22) Filed: Jun. 29, 2022

(30) Foreign Application Priority Data
Dec. 10, 2021 (CN) 202111505148.7
Dec. 10, 2021 (TW) 110146367

(51) Int. Cl. B32B 17/10; B32B 27/30; B32B 27/08; B32B 27/22

(52) U.S. Cl. CPC B32B 17/10761; B32B 27/306; B32B 27/08; B32B 27/22; B32B 17/10036; B32B 2307/30; B32B 2307/732

(57) ABSTRACT

The present disclosure relates to a polymer film comprising at least one first layer and at least one second layer, the first layer and the second layer each comprising a polyvinyl acetal resin and a plasticizer; wherein the polymer film has a first loss factor peak value at −20° C. to 20° C., and a second loss factor peak value at 20° C. to 50° C.; wherein the polymer film has a loss factor valley value between the first loss factor peak value and the second loss factor peak value, the loss factor valley value is 0.15 to 0.45, and the loss factor of the polymer film at 10° C. is less than 0.5. The polymer film can still maintain good sound insulation performance at a specific ambient temperature and/or after a period of time.

### BACKGROUND OF THE INVENTION

### 1. Technical Field

The present invention relates mainly to a polymer film and more particularly to a polymer film suitable for use as an intermediate film in laminated glass.

### 2. Description of Related Art

Laminated glass (also known as sandwich glass) is a type of safety glass that can stay in one piece when shattered. Laminated glass includes a film sandwiched between two or more layers of glass, and the film is generally a polymer film made from polyvinyl butyral resin (PVB) or ethylene-vinyl acetate (EVA). The film can keep the glass layers bonded together even when the laminated glass is broken, and the film is so strong that it prevents the laminated glass from breaking into large sharp pieces. A typical “spider web” crack pattern, however, tends to result when an impact force acting on the laminated glass is not great enough to puncture the glass.

In addition to having the safety feature stated above, laminated glass can be adapted for soundproofing. Laminated glass that provides both safety and noise reduction can be, and has been, used in vehicles and buildings. Compared with a single glass window pane of the same thickness, laminated glass is superior in sound wave attenuation thanks to the film in the glass. To further enhance its soundproofing effect, the film in soundproof laminated glass may adopt a multilayer structure in order for the difference between the materials of the multilayer structure to bring about effective reduction of the sound wave energy propagating through the film.

More specifically, the soundproofing effect of the aforesaid film is related to the properties of the film materials, such as viscoelasticity, which is a combination of viscosity and elasticity, i.e., a combination of the flow characteristics of a viscous fluid and an elastic fluid. By modulating the viscoelasticity of the polymer film structure, sound passing therethrough can be subjected to interference of the mediums so that the sound waves are converted into stored energy and expended energy associated with molecular motion in the film materials to reduce the volume of the sound.

### BRIEF SUMMARY OF THE INVENTION

This part of the specification aims to provide a brief summary of the invention so as to enable a basic understanding of the invention. The brief summary of the invention is neither a complete description of the invention nor intended to point out the important or key elements of certain embodiments of the invention or define the scope of the invention.

The inventor of the present invention has found that the soundproofing-related properties of existing polymer films are still in doubt. First, the soundproofing performance of a polymer film varies with temperature. For example, the soundproofing performance of a multilayer film may be lowered at various temperatures if there is no significant difference in viscoelasticity between the layers. It is therefore important to find ways to maintain the desired soundproofing effect at a specific temperature or specific temperatures. Second, as a polymer film typically contains a plasticizer, which may migrate within the polymer film over time until equilibrium is reached, consideration must be given to the effect of plasticizer migration on soundproofing performance, and it has been a major issue in the polymer film industry to prevent prolonged storage or use from compromising the soundproofing performance of a polymer film. In view of the above, one objective of the present invention is to provide a polymer film whose soundproofing performance remains desirable at specific ambient temperatures (in particular low temperatures) and/or after a certain period of time.

More specifically, one aspect of the present invention provides a polymer film comprising at least one first layer and at least one second layer, the first layer and the second layer each comprising a polyvinyl acetal resin and a plasticizer; the polymer film has a first loss factor peak value at −20° C. to 20° C., and has a second loss factor peak value at 20° C. to 50° C. In addition, the polymer film has a loss factor valley value between the first loss factor peak value and the second loss factor peak value, the loss factor valley value ranging from 0.15 to 0.45; and the polymer film has a loss factor less than 0.5 at 10° C.

According to an embodiment of the present invention, the first loss factor peak value is greater than the second loss factor peak value; preferably, the ratio of the first loss factor peak value to the second loss factor peak value ranges from 1.7 to 3.0.

According to an embodiment of the present invention, the first loss factor peak value ranges from 0.80 to 1.50.

According to an embodiment of the present invention, the second loss factor peak value ranges from 0.30 to 0.90.

According to an embodiment of the present invention, the plasticizer in the first layer is in an amount of 50 to 90 parts by weight while the polyvinyl acetal resin in the first layer is in an amount of 100 parts by weight; and the plasticizer in the second layer is in an amount of 30 to 60 parts by weight while the polyvinyl acetal resin in the second layer is in an amount of 100 parts by weight.

According to an embodiment of the present invention, the polyvinyl acetal resin in the first layer is obtained through an acetalization reaction between polyvinyl alcohol (PVA) and an aldehyde, and the polyvinyl alcohol for use in synthesizing the polyvinyl acetal resin has a solid content greater than 12%.

According to an embodiment of the present invention, the polyvinyl acetal resin in the first layer has a bulk density ranging from 0.200 to 0.250.

According to an embodiment of the present invention, the polyvinyl acetal resin in the first layer has a degree of polymerization ranging from 1800 to 4000.

According to an embodiment of the present invention, the polyvinyl acetal resin in the first layer has a degree of acetylation, a degree of polymerization, and a hydroxyl group content and satisfies one of the following conditions: when the degree of acetylation is greater than 12 mol %, the degree of polymerization ranges from 3000 to 4000, and the hydroxyl group content is greater than 26 mol %; when the degree of acetylation ranges from 8 mol % to 12 mol %, the degree of polymerization ranges from 2000 to 3200, and the hydroxyl group content is less than 26%; and when the degree of acetylation is greater than 4 mol % and less than 8 mol %, the degree of polymerization ranges from 1800 to 3200, and the hydroxyl group content is less than 26 mol %.

According to an embodiment of the present invention, the polymer film is a three-layer structure consisting of an upper layer formed by a first said second layer, a lower layer formed by a second said second layer, and one said first layer sandwiched between the upper layer and the lower layer.

According to an embodiment of the present invention, the loss factor of the polymer film is greater than 0.15 when measured at 10° C. according to ISO 16940: Measurement of the Mechanical Impedance of Laminated Glass on a 28^{th} day after completion of preparation of the polymer film.

According to an embodiment of the present invention, the loss factor of the polymer film is greater than 0.25 when measured at 20° C. according to ISO 16940: Measurement of the Mechanical Impedance of Laminated Glass on a 28^{th} day after completion of preparation of the polymer film.

According to an embodiment of the present invention, the loss factor of the polymer film is greater than 0.15 when measured at 30° C. according to ISO 16940: Measurement of the Mechanical Impedance of Laminated Glass on a 28^{th} day after completion of preparation of the polymer film.

According to an embodiment of the present invention, the loss factor of the polymer film at 10° C. has a variation over time greater than 0%, the variation over time being calculated as: (the loss factor of the polymer film measured on a 28^{th} day after completion of preparation of the polymer film−the loss factor of the polymer film measured on a first day after completion of the preparation of the polymer film)/the loss factor of the polymer film measured on the first day after completion of the preparation of the polymer film*100%; wherein the loss factor is measured at 10° C. according to ISO 16940: Measurement of the Mechanical Impedance of Laminated Glass.

According to an embodiment of the present invention, the loss factor of the polymer film at 20° C. has a variation over time greater than 0%, the variation over time being calculated as: (the loss factor of the polymer film measured on a 28^{th} day after completion of preparation of the polymer film−the loss factor of the polymer film measured on a first day after completion of the preparation of the polymer film)/the loss factor of the polymer film measured on the first day after completion of the preparation of the polymer film*100%; wherein the loss factor is measured at 20° C. according to ISO 16940: Measurement of the Mechanical Impedance of Laminated Glass.

According to an embodiment of the present invention, the loss factor of the polymer film at 30° C. has a variation over time greater than −10%, the variation over time being calculated as: (the loss factor of the polymer film measured on a 28^{th} day after completion of preparation of the polymer film−the loss factor of the polymer film measured on a first day after completion of the preparation of the polymer film)/the loss factor of the polymer film measured on the first day after completion of the preparation of the polymer film*100%; wherein the loss factor is measured at 30° C. according to ISO 16940: Measurement of the Mechanical Impedance of Laminated Glass.

According to an embodiment of the present invention, the polymer film is used as an intermediate film in laminated glass, and its thickness is 0.5 to 2 mm.

According to an embodiment of the present invention, the polymer film has a thickness of 0.8 mm, with the upperd layer having a thickness of 0.335 mm, the first layer having a thickness of 0.13 mm, and the lower layer having a thickness of 0.335 mm.

The present invention is advantageous in that, based on the features defined herein, the polymer film provided by the invention can maintain its desirable soundproofing performance at specific ambient temperatures and/or after a certain period of time.

### BRIEF DESCRIPTION OF THE SEVERAL VIEWS OF THE DRAWINGS

The foregoing and other objectives, features, and advantages of the present invention can be better understood by referring to the following detailed description of some illustrative embodiments in conjunction with the accompanying drawings, in which:

FIG. 1 is a plot showing the variation of the loss factor of the polymer film in one embodiment of the invention with respect to temperature;

FIG. 2 to FIG. 4 are sectional views showing the laminated layers of the polymer films in different embodiments of the invention; and

FIG. 5 is a flowchart of the polymer film manufacturing process in one embodiment of the invention.

In accordance with common practice, the various features and elements in the drawings are not drawn to scale, but are drawn in order to best represent specific features and elements relevant to the present invention. Otherwise, the same or similar reference numerals are used to refer to similar elements and parts among the different drawings.

### DETAILED DESCRIPTION OF THE INVENTION

In order to make the description of the present invention more detailed and complete, the following provides an illustrative description for the implementation aspects and specific embodiments of the present invention, but this is not the only way to implement or use the specific embodiments of the present invention. In this specification and the scope of the appended claims, “a” and “the” may also be construed as plural unless the context dictates otherwise. In addition, within the scope of this specification and the appended patent applications, unless otherwise stated, “disposed on something” can be regarded as directly or indirectly in contact with the surface of something by attachment or other forms. The definition of the surface judgment should be based on the context/paragraph semantics of the description and common knowledge in the field to which this description pertains.

Notwithstanding that the numerical ranges and parameters used to define the invention are approximate numerical values, the numerical values set forth in the specific examples have been presented as precisely as possible. Any numerical value, however, inherently contains the standard deviation resulting from individual testing methods. As used herein, “about” generally means that the actual value is within plus or minus 10%, 5%, 1%, or 0.5% of a particular value or a range. Alternatively, the word “about” means that the actual value lies within an acceptable standard error of the mean, as determined by one of ordinary skill in the art to which this invention pertains. Therefore, unless otherwise stated to the contrary, the numerical parameters disclosed in this specification and the accompanying claims are approximate numerical values and may be changed as required. At a minimum, these numerical parameters should be construed to mean the number of significant digits indicated and the numerical values obtained by applying ordinary rounding.

The present invention provides a polymer film that includes at least one first layer and at least one second layer. Each of the first layer and the second layer includes a polyvinyl acetal resin and a plasticizer. More specifically, the polyvinyl acetal resin referred to herein is a resin composition prepared by condensation of polyvinyl alcohol (PVA) with an aldehyde. The PVA may be obtained through saponification of a polyvinyl ester, with the degree of saponification of the PVA generally ranging from 70 mol % to 99.9 mol %, such as 70 mol %, 75 mol %, 80 mol %, 85 mol %, 90 mol %, 95 mol %, 99 mol % or 99.9 mol %. The aldehyde is generally an aldehyde with a carbon number ranging from 1 to 10, such as methanol (also known as formaldehyde), ethanal (also known as acetaldehyde), propanal (also known as propionaldehyde), butanal (also known as butyraldehyde), isobutyraldehyde, pentanal (also known as valeraldehyde), 2-ethylbutyraldehyde, hexanal (also known as caproaldehyde), octanal, nonanal (also known as pelargonaldehyde), decanal (also known as capraldehyde), or benzaldehyde. Preferably, the aldehyde is propionaldehyde, butyraldehyde, isobutyraldehyde, caproaldehyde, or valeraldehyde. More preferably, the aldehyde is propionaldehyde, butyraldehyde, or isobutyraldehyde. In one embodiment of the invention, the polyvinyl acetal is polyvinyl butyral (PVB).

The plasticizer, which is often used in conjunction with a polyvinyl acetal resin to modulate the viscoelasticity of the resulting material, may be selected from the group consisting of a monobasic ester, a polybasic ester, an organic phosphoric acid, and an organic phosphorous acid, without limitation. More specifically, the plasticizer may be selected from the group consisting of triethylene glycol bis(2-ethylhexanoate) (3GO), tetraethylene glycol bis(2-ethylhexanoate), triethylene glycol bis(2-ethylbutanoate), tetraethylene glycol bis(2-ethylbutanoate), triethylene glycol diheptanoate, tetraethylene glycol diheptanoate, dihexyl adipate, dioctyl adipate, hexyl cyclohexyl adipate, diisononyl adipate, heptyl nonyl adipate, dibutyl sebacate, bis[2-(2-butoxyethoxy)ethyl] adipate, polyadipate, propylene glycol dibenzoate, dipropylene glycol dibenzoate, tripropylene glycol dibenzoate, polypropylene glycol dibenzoate, 2,2,4-trimethyl-1,3-pentanediyl dibenzoate, isodecyl benzoate, 2-ethylhexyl benzoate, di-isononyl phthalate, dibutoxy ethyl terephthalate, castor oil, methyl ricinoleate, soybean oil, and epoxidized soybean oil.

The polymer film has a first loss factor peak value at a temperature ranging from −20° C. to 20° C., a second loss factor peak value at a temperature ranging from 20° C. to 50° C., and a loss factor valley value between the first loss factor peak value and the second loss factor peak value, wherein the loss factor valley value ranges from 0.15 to 0.45. Moreover, the loss factor of the polymer film at 10° C. is less than 0.5. In at least one embodiment, the first loss factor peak value is greater than the second loss factor peak value. As used herein, the term “loss factor (value)” refers to the tan δ value (also known as the damping factor or the loss tangent), which indicates one of the viscoelasticity properties, or more specifically the damping characteristic, of a material and is equivalent to the ratio of the loss modulus (G″, also known as the viscosity modulus) to the storage modulus (G′, also known as the elasticity modulus) of the material. The loss factor value peak at a temperature is known as the glass transition temperature (Tg). Herein, the temperature at which the first loss factor peak value occurs is also referred to as the first glass transition temperature, and the temperature at which the second loss factor peak value occurs is also referred to as the second glass transition temperature. Generally, the value of the loss factor is in direct proportion to the viscosity of the material; a lower glass transition temperature roughly indicates a softer material. In the present invention, the viscoelasticity of the material of interest is controlled by adjusting the bulk density, the degree of polymerization, and the percentage of a functional group at the same time.

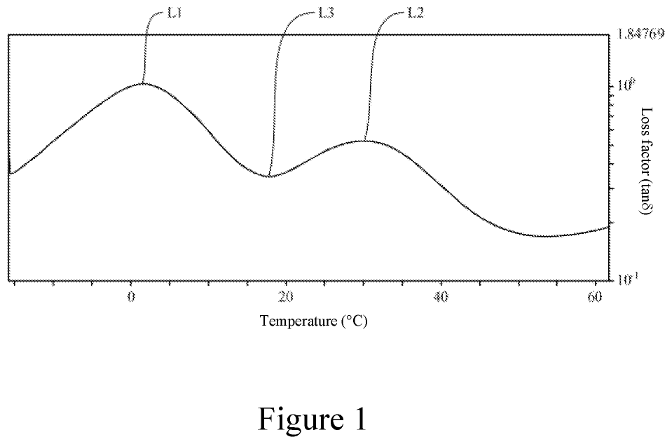

FIG. 1 is a plot showing by way of example the variation of the loss factor (Imo) of the polymer film in a preferred embodiment of the present invention with respect to temperature (° C.). In short, FIG. 1 shows how the loss factor of the polymer film varies with temperature. As shown in FIG. 1, a first loss factor peak value L1 occurs at a temperature ranging from −20° C. to 20° C., and a second loss factor peak value L2 occurs at a temperature ranging from 20° C. to 50° C. It can also be seen in FIG. 1 that a loss factor valley value L3 occurs between the first loss factor peak value L1 and the second loss factor peak value L2 and ranges from 0.15 to 0.45. In addition, the loss factor of the polymer film is less than 0.5 at 10° C.

In at least one preferred embodiment of the present invention, the polymer film has a loss factor valley value ranging from 0.18 to 0.43, such as 0.18, 0.21, 0.25, 0.28, 0.32, 0.35, 0.39 or 0.43. In at least one preferred embodiment of the invention, the loss factor of the polymer film at 10° C. ranges from 0.10 to 0.49, preferably from 0.25 to 0.47, such as 0.25, 0.32, 0.37, 0.42 or 0.47.

The temperature at which the first loss factor peak value of the polymer film occurs ranges from −20° C. to 20° C., preferably from −10° C. to 10° C., more preferably from −5° C. to 5° C. In at least one preferred embodiment of the present invention, the first loss factor peak value occurs at a temperature ranging from −2.5° C. to 1.6° C., such as 2.5° C., 1.5° C., 0.5° C., 1.4° C. or 1.6° C. As to the second loss factor peak value of the polymer film, the temperature at which it occurs ranges from 20° C. to 50° C., preferably from 25° C. to 45° C., more preferably from 30° C. to 40° C. In at least one preferred embodiment of the invention, the second loss factor peak value occurs at a temperature ranging from 31.8° C. to 33.6° C., such as 31.8° C., 32.4° C., 33.2° C., 33.5° C. or 33.6° C.

The ratio of the first loss factor peak value to the second loss factor peak value of the polymer film ranges from 1.7 to 3.0, such as 1.85, 1.94, 2.12, 2.37 or 2.96. In at least one preferred embodiment of the present invention, the first loss factor peak value ranges from 0.80 to 1.50, such as 0.952, 1.022, 1.182, 1.252 or 1.482, and the second loss factor peak value ranges from 0.30 to 0.90, such as 0.501, 0.517, 0.526, 0.529 or 0.558.

In the polymer film, the plasticizer in the first layer is in the amount of 50 to 90 parts by weight, preferably 60 to 90 parts by weight, more preferably 60 to 70 parts by weight, while the polyvinyl acetal resin in the first layer is in the amount of 100 parts by weight. In at least one preferred embodiment of the present invention, the plasticizer in the first layer is in the amount of 60 parts by weight while the polyvinyl acetal resin in the first layer is in the amount of 100 parts by weight. As to the second layer, the plasticizer therein is in the amount of 30 to 60 parts by weight, preferably 35 to 55 parts by weight, more preferably 40 to 50 parts by weight, while the polyvinyl acetal resin in the second layer is in the amount of 100 parts by weight. In at least one preferred embodiment of the invention, the plasticizer in the second layer is in the amount of 40 parts by weight while the polyvinyl acetal resin in the second layer is in the amount of 100 parts by weight.

In the polymer film, the polyvinyl acetal resin in the first layer is obtained through an acetalization reaction between polyvinyl alcohol (PVA) and an aldehyde, wherein the PVA for use in synthesizing the polyvinyl acetal resin has a solid content greater than 12%. In at least one preferred embodiment of the present invention, the PVA for use in synthesizing the polyvinyl acetal resin has a solid content of 12.1%, 12.7%, 13.5%, 13.9% or 14.8%. Correspondingly, the polyvinyl acetal resin in the first layer has a bulk density ranging from 0.200 to 0.250, and in at least one preferred embodiment of the invention, the polyvinyl acetal resin in the first layer has a bulk density of 0.206, 0.218, 0.223, 0.231 or 0.245. The inventor has found that by increasing the bulk density (and hence surface area) of the polyvinyl acetal resin in the first layer during the manufacturing process of the layer, the amount of the plasticizer that can be adsorbed can be increased to enhance the softness, and consequently the sound insulation effect, of the material.

Furthermore, the polyvinyl acetal resin in the first layer has a degree of polymerization ranging from 1800 to 4000, and the aforementioned degree of polymerization is, for example, but not limited to: 1800, 2000, 2500, 3000, 3500 or 4000. In at least one preferred embodiment of the present invention, the polyvinyl acetal resin in the first layer satisfies one of the following conditions: when the degree of acetylation of the polyvinyl acetal resin is greater than 12 mol %, the degree of polymerization of the polyvinyl acetal resin ranges from 3000 to 4000, and the hydroxyl group content of the polyvinyl acetal resin is greater than 26 mol %; when the degree of acetylation ranges from 8 mol % to 12 mol %, the degree of polymerization ranges from 2000 to 3200, and the hydroxyl group content is less than 26%; and when the degree of acetylation is greater than 4 mol % and less than 8 mol %, the degree of polymerization ranges from 1800 to 3200, and the hydroxyl group content is less than 26 mol %. At least one preferred embodiment of the invention is such that when the degree of acetylation of the polyvinyl acetal resin in the first layer is 15.5 mol %, the degree of polymerization of the polyvinyl acetal resin is 3600, and the hydroxyl group content of the polyvinyl acetal resin is 26.4 mol %; when the degree of acetylation is 8.5 mol %, the degree of polymerization is 2400, and the hydroxyl group content is 23.8%; and when the degree of acetylation is 4.8 mol %, 6.7 mol %, or 7.9 mol %, the degree of polymerization is 2800, 2200, or 1900 respectively, and the hydroxyl group content is 25.6, 25.2, or 25.4 mol % respectively.

As used herein, the term “hydroxyl group content” of a polyvinyl acetal resin refers to a mole faction calculated by dividing the amount of ethylene bonded to the hydroxyl groups by the total amount of ethylene on the carbon backbone and multiplying the quotient by 100%. The term “degree of acetalization” of a polyvinyl acetal resin refers to a mole faction calculated by dividing the amount of ethylene bonded to the acetal groups by the total amount of ethylene on the carbon backbone and multiplying the quotient by 100%. The term “degree of acetylation” of a polyvinyl acetal resin refers to a mole fraction calculated by subtracting the amount of ethylene bonded to the hydroxyl groups and the amount of ethylene bonded to the acetal groups from the total amount of ethylene on the carbon backbone, dividing the difference by the total amount of ethylene on the carbon backbone, and multiplying the quotient by 100%.

More specifically, the hydroxyl group content, the degree of acetalization, and the degree of acetylation are calculated according to test results obtained by JIS K6728 “Testing Methods for Polyvinyl Butyral”. The bulk density is determined according to JIS

As used herein, the term “degree of polymerization” is an indicator of the size of a polymer molecule. Based on the number of repeated units, the degree of polymerization of a polymer is the average of the numbers of repeated units on the macromolecular chains.

Structural Aspects of the Polymer Film

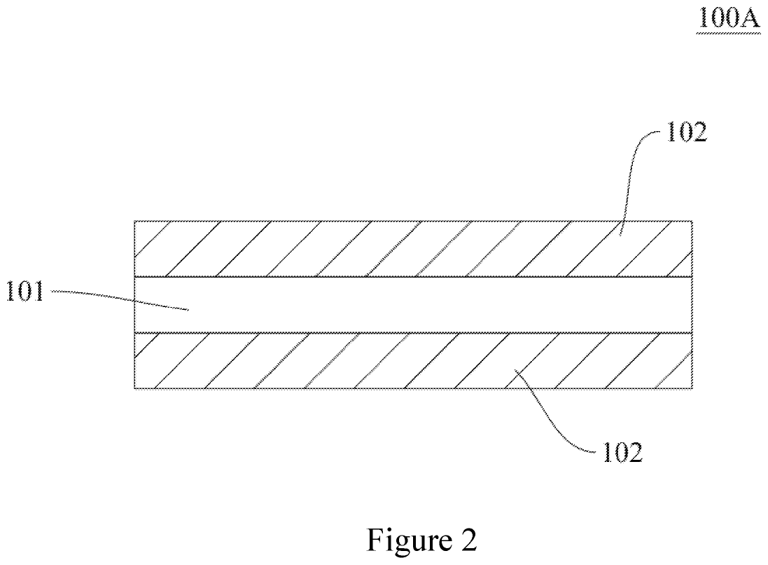

FIG. 2 to FIG. 4 are sectional views showing the laminated layers of the polymer films in different embodiments of the present invention. The polymer films in those embodiments are different in structure.

FIG. 2 is a sectional view showing the laminated layers of the polymer film 100A in one embodiment of the present invention. As shown in FIG. 2, the polymer film 100A is a three-layer structure in which both the upper and the lower layers are second layers 102, and in which a first layer 101 lies between the two second layers 102. In some embodiments of the invention, the polymer film 100A can be used as an intermediate film in laminated glass by being provided between two sheets of glass, with the first layer 101 serving as an interlayer, and the second layers 102 serving as protective layers. In at least one embodiment, the protective layers may be common resin layers and relatively hard, and the interlayer may be a soundproof resin layer and relatively soft. The inventor has found that the greater the difference in viscoelasticity (tan δ value) between the common resin layers (i.e., protective layers) and the soundproof resin layer (i.e., the interlayer), the softer the interlayer material tends to be than the protective-layer material at the same temperature (indicating the more plasticizer the interlayer may have absorbed), and that the more plasticizer the interlayer has absorbed, the greater the difference in viscoelasticity between the protective layers and the interlayer will be at different temperatures (which means the better the soundproofing performance). As to thickness, the polymer film 100A has a thickness ranging from 0.5 mm to 2 mm, such as 0.5, 0.6, 0.7, 0.8, 0.9, 1.0, 1.1, 1.2, 1.3, 1.4, 1.5, 1.6, 1.7, 1.8, 1.9 or 2.0 mm. Preferably, the thickness of the polymer film 100A is 0.8 mm, with the thickness of the first layer 101 ranging from 0.11 mm to 0.15 mm, preferably being 0.13 mm, and the thickness of each second layer 102 ranging from 0.320 mm to 0.350 mm, preferably being 0.335 mm.

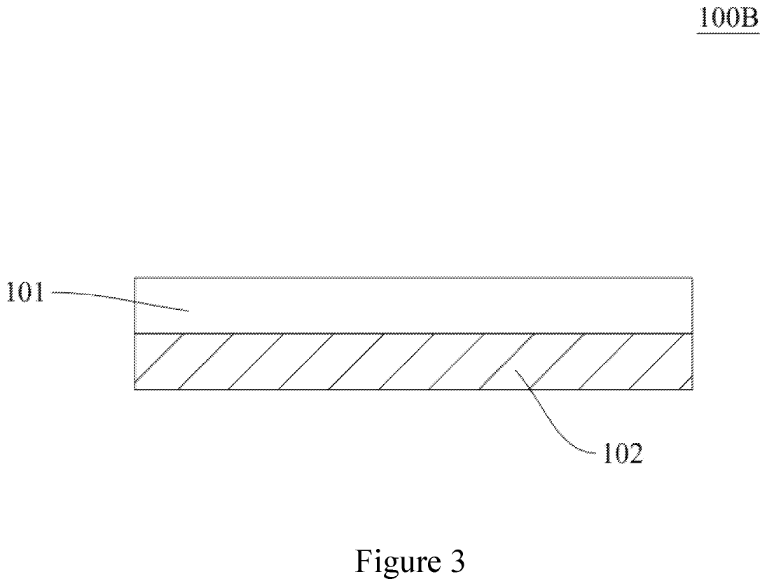

FIG. 3 is a sectional view showing the laminated layers of the polymer film 100B in one embodiment of the present invention. The polymer film 100B is similar to the polymer film 100A in the previous embodiment, the difference being that the polymer film 100B is a double-layer structure formed by laminating a first layer 101 and a second layer 102 together.

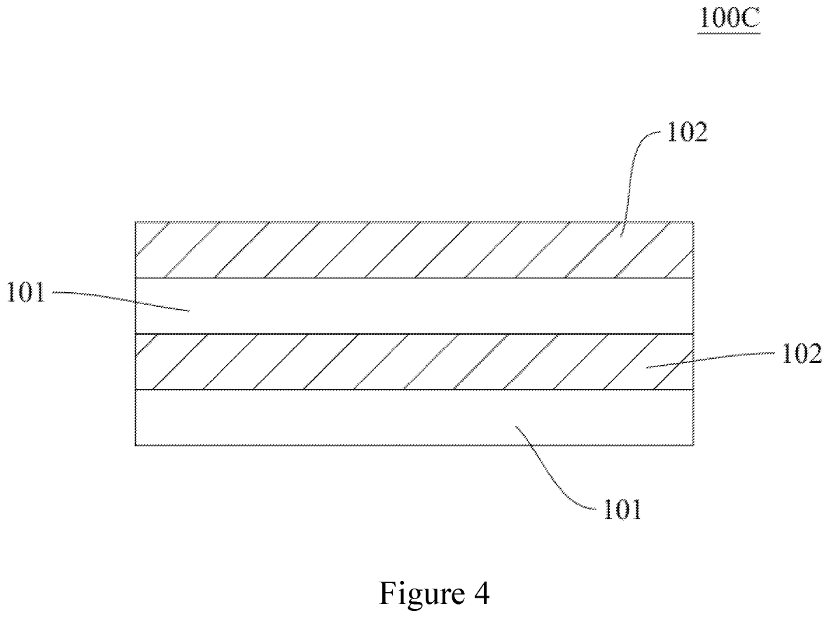

FIG. 4 is a sectional view showing the laminated layers of the polymer film 100C in one embodiment of the present invention. The polymer film 100C is similar to the polymer film 100A, the difference being that the polymer film 100C includes an additional first layer 101 bonded to the upper or the lower second layer 102. Apart from the embodiments described above, a person of ordinary skill in the art may add at least one first layer 101 or second layer 102 to the polymer film 100C in an alternating manner so as to form a five-layer, six-layer, or more-than-six-layer structure as needed, without departing from the concept of the invention.

Manufacturing Process of the Polymer Film

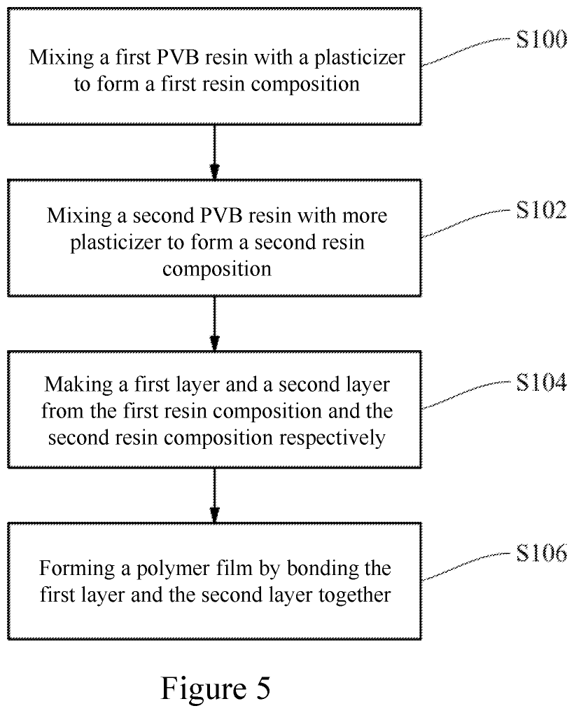

FIG. 5 is a flowchart of the polymer film manufacturing process in one embodiment of the present invention. As shown in FIG. 5, the polymer film manufacturing process of the invention at least includes steps S100 to S106. More specifically, step S100 involves mixing a first PVB resin with a plasticizer to form a first resin composition, wherein the operation temperature and rotation speed of the mixing process can be adjusted according to conventional methods and practical needs; the invention has no limitation on the details of the process conditions. In step S102, a second PVB resin is mixed with more plasticizer to form a second resin composition, wherein the operation temperature and rotation speed of the mixing process can be adjusted according to conventional methods and practical needs; the invention has no limitation on the details of the process conditions, either. In step S104, the first resin composition and the second resin composition are made into a first layer and a second layer respectively, wherein the method for making the layers may be a conventional film preparation method such as extrusion or thermoforming. In step S106, the first layer and the second layer are bonded together to form a polymer film, wherein the bonding method may be a conventional film preparation method such as extrusion or thermoforming. In some embodiments of the invention, the first resin composition and the second resin composition may form a polymer film directly by coextrusion. The polymer film made by the foregoing manufacturing process serves as a to-be-tested film and is subjected to the following property tests.

Determination of Viscoelasticity

The method used for the determination of viscoelasticity at least includes the following steps: First, a to-be-tested film is cut into a circle with a diameter of 8 mm, and the circular to-be-tested film is put into a thermo-hygrostat for 24 hours, during which the temperature and relative humidity of the thermo-hygrostat are kept at 23° C. and 55% respectively. After that, the to-be-tested film is placed in a rotational shear rheometer (Discovery Hybrid Rheometer (DHR) II, manufactured by TA Instrument) in order to carry out viscoelasticity analysis by the oscillation method, wherein the analysis conditions are: the test temperature being lowered from 100° C. to −10° C. at a temperature reduction rate of 3° C./min, the oscillation frequency being set at 1 Hz, the strain of the film under test being kept at 1%, and the fixture pressure being set at 1 N. The loss factor and glass transition temperature of the film under test are derived from the analysis result.

Determination of the Loss Factor

The method used to determine the loss factor is based on ISO 16940: Measurement of the Mechanical Impedance of Laminated Glass. More specifically, the method at least includes the following steps: First, a to-be-tested film is sandwiched between two pieces of clean, transparent float glass each having a length of 300 mm, a width of 25 mm, and a thickness of 2 mm. Next, a pre-pressing process is performed, followed by an autoclave process to complete the preparation of a piece of laminated glass (the pre-pressing process conditions including pre-pressing with a hot press at 150° C. for 3 minutes, and the autoclave process conditions including pressing at 135° C. and with a pressure of 13 bar for 120 minutes). On the first or the 28^{th} day after the completion of its preparation, and before being tested, the laminated glass is placed in a thermo-hygrostat for 2 hours, during which the temperature and relative humidity of the thermo-hygrostat are regulated so as to stay at 10° C./20° C./30° C. and 55% respectively. The center of the laminated glass is then secured on a vibration shaker, before the laminated glass is vibrated at an ambient temperature of 10° C./20° C./30° C. The force and frequency of the vibrations are measured with an impedance head, and the experiment data is converted by an analysis system into the damping loss factor (also known as the loss factor). It should be pointed out that the loss factor is based on the first vibration mode calculated by the half-power method, and that it is generally believed that the greater the value of the loss factor, the better the soundproofing effect.

In at least one preferred embodiment of the present invention, the polymer film is used as an intermediate film in laminated glass and has a thickness ranging from 0.5 mm to 2 mm, a loss factor greater than 0.15 when measured at 10° C. according to ISO 16940: Measurement of the Mechanical Impedance (MIM) of Laminated Glass on the 28^{th} day after the completion of the preparation of the laminated glass, a loss factor greater than 0.25 when measured at 20° C. according to ISO 16940: Measurement of the Mechanical Impedance (MIM) of Laminated Glass on the 28^{th} day after the completion of the preparation of the laminated glass, and a loss factor greater than 0.15 when measured at 30° C. according to ISO 16940: Measurement of the Mechanical Impedance (MIM) of Laminated Glass on the 28^{th} day after the completion of the preparation of the laminated glass.

In addition, the term “variation of the loss factor over time” as used herein refers to the percentage by which the loss factor of a polymer film in laminated glass has changed from the first day through the 28^{th} day after the completion of the preparation of the laminated glass. More specifically, variation of the loss factor over time is calculated by the following equation:

$$Variation of the loss factor over time ( \% ) = \frac{\begin{matrix}loss factor on the {28}^{th} day after preperation - \\ loss factor on the first day after preperation\end{matrix}}{loss factor on the first day after preparation} \times 100 ( \% ) .$$

Variation of the loss factor over time is used to evaluate variation of the soundproofing effect over time. In some embodiments of the present invention, the variation of the loss factor of the polymer film at 10° C. over time is greater than 0%, or the variation of the loss factor of the polymer film at 20° C. over time is greater than 0%, or the variation of the loss factor of the polymer film at 30° C. over time is greater than −10%. The inventor of the present invention has found that when a conventional three-layer polymer film is at an ambient temperature of 30° C., which is close to the glass transition temperatures of the film layers (which are equivalent to the first and the second layers in the invention), the polymer film tends to soften and exhibit unstable plasticizer migration such that its soundproofing effect is bound to be lessened over time. The invention, by contrast, can lower the extent to which the soundproofing effect is reduced at 30° C.

Generally, the longer a polymer film is stored or used, the more likely plasticizer migration is to take place, and hence the more plasticizer the relatively soft layer of the polymer film (e.g., the first layer in the present invention) is able to adsorb to produce a better soundproofing effect. However, the inventor has found that if the loss factor of the polymer film of the invention has too small a valley value between the glass transition temperature of the first layer and the glass transition temperature of the second layer (meaning the first and the second layers of the polymer film exhibit too great a difference in compatibility with the plasticizer), not only will the plasticizer keep migrating, but also the migration will be unstable over time such that the soundproofing effect is reduced; and that if the loss factor has too great a valley value instead (meaning the glass transition temperature of the first layer and the glass transition temperature of the second layer are too close to each other, i.e., the difference in viscoelasticity between the first and the second layers is too small), the lack of a significant difference between the layers (i.e., between the mediums through which sound waves propagate) will compromise the soundproofing effect of the polymer film as a whole. In light of the above, the loss factor valley value should be within a proper range to, on the one hand, prevent the soundproofing effect from being reduced over time and, on the other hand, enhance soundproofing performance at low temperatures. Besides, the loss factor being less than a specific value at 10° C. indicates that the polymer film has a good soundproofing effect.

### Embodiments 1 to 5

The polymer films in embodiments 1 to 5 of the present invention were provided according to the foregoing contents and were made with different parameters so as to have different properties respectively. The loss factor properties of the polymer films were analyzed.

It should be pointed out that embodiments 1 through 5 used a three-layer structure in which the second layer in the present invention was provided as each of the upper and the lower protective layers while the first layer in the invention was provided as the interlayer.

The preparation method of the polymer films in embodiments 1 to 5 is briefly described as follows:

To begin with, 100 parts by weight of a first PVB resin and 60 parts by weight of a plasticizer (triethylene glycol bis(2-ethylhexanoate)) were sufficiently mixed in a mixer to produce a resin composition for use in the interlayer, and 100 parts by weight of a second PVB resin and 40 parts by weight of the same plasticizer (triethylene glycol bis(2-ethylhexanoate)) were sufficiently mixed in a mixer to produce a resin composition for use in the protective layers. When preparing the first PVB resin, an increase in the solid content of the PVA resin for use to synthesize the first PVB resin and in the amount of the added acid was effective in reducing the particle size, and increasing the bulk density, of the first PVB resin.

Next, the resin composition for use in the interlayer and the resin composition for use in the protective layers were coextruded through a T-die coextruder to produce an intermediate film having a three-layer structure (thickness: 0.8 mm). The three-layer structure consisted of a protective layer (thickness: 0.335 mm), an interlayer (thickness: 0.13 mm), and another protective layer (thickness: 0.335 mm).

### Comparative Examples 1 to 4

The polymer films in comparative examples 1 to 4 were provided by a preparation method similar to but not the same as that used for embodiments 1 to 5. Comparative examples 1 to 4 were nevertheless identical to embodiments 1 to 5 in that the resin compositions for use in the interlayer and in the protective layers were obtained by mixing their respective ingredients in the same proportions by weight as in embodiments 1 to 5, and that all the polymer films in the comparative examples were of a three-layer structure consisting of an upper protective layer, a lower protective layer, and an interlayer between the two protective layers.

The ingredient parameters of embodiments 1 to 5 and of comparative examples 1 to 4 are detailed in Table 1.

TABLE 1

| | | | | Embodi- | Embodi- | Embodi- | Embodi- |
|---|---|---|---|---|---|---|---|
| | | | | ment | ment | ment | ment |
| | | | Unit | 1 | 2 | 3 | 4 |
| Inter | PVB | Solid | | 13.5% | 12.7% | 14.8% | 13.9% |
| layer | resin | content of | | | | | |
| | | PVA for use | | | | | |
| | | in synthesis | | | | | |
| | | Bulk density | | 0.223 | 0.218 | 0.245 | 0.231 |
| | | Degree of | | 2400 | 2200 | 3600 | 2800 |
| | | polymerization | | | | | |
| | | Hydroxyl | mol % | 23.8 | 25.2 | 26.4 | 25.6 |
| | | group | | | | | |
| | | content | | | | | |
| | | Degree of | mol % | 8.5 | 6.7 | 15.5 | 4.8 |
| | | acetylation | | | | | |
| | | Degree of | mol % | 67.7 | 68.1 | 58.1 | 69.6 |
| | | acetalization | | | | | |
| | Plasticizer | Content | phr | 60 | 60 | 60 | 60 |
| Protective | PVB | Bulk density | | 0.252 | 0.256 | 0.248 | 0.25 |
| layers | resin | Degree of | | 1800 | 1800 | 1800 | 1800 |
| | | polymerization | | | | | |
| | | Hydroxyl | mol % | 28.3 | 28.4 | 28.4 | 28.2 |
| | | group | | | | | |
| | | content | | | | | |
| | | Degree of | mol % | 0.4 | 0.4 | 0.4 | 0.6 |
| | | acetylation | | | | | |
| | | Degree of | mol % | 71.3 | 71.2 | 71.2 | 71.2 |
| | | acetalization | | | | | |
| | Plasticizer | Content | phr | 40 | 40 | 40 | 40 |
| | | | Embodi- | Comparative | Comparative | Comparative | Comparative |
| | | | ment | example | example | example | example |
| | | | 5 | 1 | 2 | 3 | 4 |
| Inter | PVB | Solid | 12.1% | 10.3% | 11.6% | 14.0% | 10.4% |
| layer | resin | content of | | | | | |
| | | PVA for use | | | | | |
| | | in synthesis | | | | | |
| | | Bulk density | 0.206 | 0.187 | 0.194 | 0.240 | 0.189 |
| | | Degree of | 1900 | 2500 | 4200 | 2000 | 1100 |
| | | polymerization | | | | | |
| | | Hydroxyl | 25.4 | 28.9 | 26.5 | 24.5 | 26.8 |
| | | group | | | | | |
| | | content | | | | | |
| | | Degree of | 7.9 | 3.2 | 8.4 | 22.8 | 3.5 |
| | | acetylation | | | | | |
| | | Degree of | 66.7 | 67.9 | 65.1 | 52.7 | 69.7 |
| | | acetalization | | | | | |
| | Plasticizer | Content | 60 | 60 | 60 | 60 | 60 |
| Protective | PVB | Bulk density | 0.253 | 0.252 | 0.257 | 0.256 | 0.257 |
| layers | resin | Degree of | 1800 | 1800 | 1800 | 1800 | 1800 |
| | | polymerization | | | | | |
| | | Hydroxyl | 28.3 | 28.5 | 28.3 | 28.3 | 28.5 |
| | | group | | | | | |
| | | content | | | | | |
| | | Degree of | 0.6 | 0.5 | 0.4 | 0.6 | 0.4 |
| | | acetylation | | | | | |
| | | Degree of | 71.1 | 71 | 71.3 | 71.1 | 71.1 |
| | | acetalization | | | | | |
| | Plasticizer | Content | 40 | 40 | 40 | 40 | 40 |

The loss factor parameter and property analysis results of embodiments 1 to 5 and of comparative examples 1 to 4 are shown in Table 2.

TABLE 2

| | | | Embodi- | Embodi- | Embodi- | Embodi- |
|---|---|---|---|---|---|---|
| | | | ment | ment | ment | ment |
| | | Unit | 1 | 2 | 3 | 4 |
| First loss factor peak | | | 1.252 | 1.182 | 1.482 | 1.022 |
| value | | | | | | |
| First glass transition | | ° C. | −1.5 | −0.5 | −2.5 | 1.6 |
| temperature | | | | | | |
| Second loss factor peak | | | 0.529 | 0.558 | 0.501 | 0.526 |
| value | | | | | | |
| Second glass transition | | ° C. | 33.5 | 32.4 | 31.8 | 33.6 |
| temperature | | | | | | |
| Loss factor value at 10° C. | | | 0.32 | 0.37 | 0.25 | 0.42 |
| Loss factor valley value | | | 0.35 | 0.39 | 0.18 | 0.43 |
| Temperature at which | | ° C. | 14 | 14.2 | 13.4 | 15.5 |
| loss factor valley occurs | | | | | | |
| First loss factor peak | | | 1 2.37 | 2.12 | 2.96 | 1.94 |
| value/second loss factor | | | | | | |
| peak value | | | | | | |
| Loss factor | 10° C. | | 0.169 | 0.162 | 0.215 | 0.144 |
| (first day) | 20° C. | | 0.283 | 0.252 | 0.303 | 0.232 |
| | 30° C. | | 0.251 | 0.265 | 0.238 | 0.268 |
| Loss factor | 10° C. | | 0.245 | 0.218 | 0.321 | 0.171 |
| (28^{th} day) | 20° C. | | 0.323 | 0.294 | 0.323 | 0.262 |
| | 30° C. | | 0.235 | 0.242 | 0.216 | 0.254 |
| Variation over | 10° C. | | 44.97% | 34.57% | 49.30% | 18.75% |
| time (%) | 20° C. | | 14.13% | 16.67% | 6.60% | 12.93% |
| | 30° C. | | −6.37% | −8.68% | −9.24% | −5.22% |
| | | Embodi- | Com- | Com- | Com- | Com- |
| | | ment | parative | parative | parative | parative |
| | | 5 | example 1 | example 2 | example 3 | example 4 |
| First loss factor peak | | 0.952 | 0.828 | 0.834 | 1.426 | 0.852 |
| value | | | | | | |
| First glass transition | | 1.4 | 5.3 | 6.4 | −7.5 | −1.2 |
| temperature | | | | | | |
| Second loss factor peak | | 0.517 | 0.527 | 0.532 | 0.525 | 0.545 |
| value | | | | | | |
| Second glass transition | | 33.2 | 33.4 | 32.7 | 31.6 | 33.4 |
| temperature | | | | | | |
| Loss factor value at 10° C. | | 0.47 | 0.64 | 0.68 | 0.23 | 0.53 |
| Loss factor valley value | | 0.32 | 0.54 | 0.42 | 0.14 | 0.42 |
| Temperature at which | | 16.2 | 18 | 18.5 | 12.5 | 17.3 |
| loss factor valley occurs | | | | | | |
| First loss factor peak | | 1.85 | 1.57 | 1.57 | 2.72 | 1.56 |
| value/second loss factor | | | | | | |
| peak value | | | | | | |
| Loss factor | 10° C. | 0.133 | 0.118 | 0.128 | 0.254 | 0.121 |
| (first day) | 20° C. | 0.248 | 0.192 | 0.242 | 0.347 | 0.231 |
| | 30° C. | 0.275 | 0.282 | 0.261 | 0.245 | 0.232 |
| Loss factor | 10° C. | 0.155 | 0.138 | 0.145 | 0.389 | 0.142 |
| (28^{th} day) | 20° C. | 0.271 | 0.226 | 0.279 | 0.292 | 0.265 |
| | 30° C. | 0.252 | 0.262 | 0.243 | 0.213 | 0.241 |
| Variation over | 10° C. | 16.54% | 16.95% | 13.28% | 53.15% | 17.35% |
| time (%) | 20° C. | 9.27% | 17.71% | 15.29% | −15.85% | 14.72% |
| | 30° C. | −8.36% | −7.09% | −6.90% | −13.06% | 3.87% |

As shown in Table 1, the PVA for use in synthesis of the polyvinyl acetal resins in the interlayers in embodiments 1 to 5 had solid contents greater than 12%, and correspondingly, the bulk densities of the polyvinyl acetal resins ranged from 0.200 to 0.250. Moreover, the polyvinyl acetal resins in the interlayers in embodiments 1 to 5 had degrees of polymerization ranging from 1800 to 4000 and satisfied one or another of the following conditions: when the degree of acetylation is greater than 12 mol %, the degree of polymerization ranges from 3000 to 4000, and the hydroxyl group content is greater than 26 mol %; when the degree of acetylation ranges from 8 mol % to 12 mol %, the degree of polymerization ranges from 2000 to 3200, and the hydroxyl group content is less than 26%; and when the degree of acetylation is greater than 4 mol % and less than 8 mol %, the degree of polymerization ranges from 1800 to 3200, and the hydroxyl group content is less than 26 mol %. By contrast, none of the interlayers in comparative examples 1 to 4 satisfied any of the foregoing conditions.

As shown in Table 2, the polymer films in embodiments 1 to 5 exhibited their first loss factor peak values at temperatures ranging from −20° C. to 20° C., preferably from −2.5° C. to 1.6° C., and their second loss factor peak values at temperatures ranging from 20° C. to 50° C., with the ratio of each first loss factor peak value to the corresponding second loss factor peak value ranging from 1.7 to 3.0. Furthermore, the loss factor valley values (each taking place between the corresponding first and second loss factor peak values) of the polymer films in embodiments 1 to 5 ranged from 0.15 to 0.45, and the loss factors of the polymer films in embodiments 1 to 5 were less than 0.5 at 10° C.

By contrast, neither of the 10° C. loss factor and the loss factor valley value of the polymer film in comparative example 1 was within the aforesaid ranges. Moreover, without being limited by specific theories, the property analysis result of the polymer film in comparative example 1 shows that the loss factors measured respectively at 10° C. and 20° C. according to ISO 16940: Measurement of the Mechanical Impedance (MIM) of Laminated Glass on the 28^{th} day after the completion of the preparation of the polymer film were both undesirable, which indicates that the polymer film had an undesirable soundproofing effect at the ambient temperatures of 10° C. and 20° C. The loss factors of the polymer films in comparative examples 2 and 4 at 10° C. were not within the aforesaid range either, and without being limited by specific theories, the property analysis results of the polymer films in comparative examples 2 and 4 show that the loss factors measured at 10° C. according to ISO 16940: Measurement of the Mechanical Impedance (MIM) of Laminated Glass on the 28^{th} day after the completion of the preparation of the polymer films were undesirable, which indicates that the polymer films had an undesirable soundproofing effect at the ambient temperature of 10° C. The loss factor valley value of the polymer film in comparative example 3 was not within the aforesaid range too, and without being limited by specific theories, the property analysis result of the polymer film in comparative example 3 shows that the loss factors measured respectively at 20° C. and 30° C. according to ISO 16940: Measurement of the Mechanical Impedance (MIM) of Laminated Glass on the first and the 28^{th} days after the completion of the preparation of the polymer film exhibited undesirable variations over time, which indicates that the soundproofing effect of the polymer film had been reduced over time at each of the ambient temperatures of 20° C. and 30° C.

According to the above, the present invention provides a polymer film suitable for use as an intermediate film in laminated glass. Different embodiments of the invention have shown that when the parameters defined herein are adjusted as stated above, the soundproofing performance of the polymer film will remain desirable at specific ambient temperatures and/or after a certain period of time.

The above is the detailed description of the present invention, but the above is merely the preferred embodiments of the present invention, and should not limit the scope of implementation of the present invention, that is, all equivalent changes and modifications according to the scope of the patent application of the present invention should still fall within the scope of the patent of the present invention.

What is claimed is:

1. A polymer film, comprising at least one first layer and at least one second layer, each of the first layer and the second layer comprising a polyvinyl acetal resin and a plasticizer;
the polymer film having a first loss factor peak value at a temperature ranging from −20° C. to 20° C. and a second loss factor peak value at a temperature ranging from 20° C. to 50° C.; and
the polymer film having a loss factor valley value between the first loss factor peak value and the second loss factor peak value, the loss factor valley value ranging from 0.15 to 0.45;
wherein the polymer film has a loss factor less than 0.5 at 10° C.

2. The polymer film of claim 1, wherein the first loss factor peak value is greater than the second loss factor peak value.

3. The polymer film of claim 1, wherein a ratio of the first loss factor peak value to the second loss factor peak value ranges from 1.7 to 3.0.

4. The polymer film of claim 2, wherein the first loss factor peak value ranges from 0.80 to 1.50.

5. The polymer film of claim 2, wherein the second loss factor peak value ranges from 0.30 to 0.90.

6. The polymer film of claim 1, wherein:
the plasticizer in the first layer is in an amount of 50 to 90 parts by weight while the polyvinyl acetal resin in the first layer is in an amount of 100 parts by weight; and
the plasticizer in the second layer is in an amount of 30 to 60 parts by weight while the polyvinyl acetal resin in the second layer is in an amount of 100 parts by weight.

7. The polymer film of claim 6, wherein the polyvinyl acetal resin in the first layer is obtained through an acetalization reaction between polyvinyl alcohol and an aldehyde, and the polyvinyl alcohol for use in synthesizing the polyvinyl acetal resin has a solid content greater than 12%.

8. The polymer film of claim 6, wherein the polyvinyl acetal resin in the first layer has a bulk density ranging from 0.200 to 0.250.

9. The polymer film of claim 6, wherein the polyvinyl acetal resin in the first layer has a degree of polymerization ranging from 1800 to 4000.

10. The polymer film of claim 6, wherein the polyvinyl acetal resin in the first layer has a degree of acetylation, a degree of polymerization, and a hydroxyl group content and satisfies one of the following conditions:
when the degree of acetylation is greater than 12 mol %, the degree of polymerization ranges from 3000 to 4000, and the hydroxyl group content is greater than 26 mol %;
when the degree of acetylation ranges from 8 mol % to 12 mol %, the degree of polymerization ranges from 2000 to 3200, and the hydroxyl group content is less than 26%; and
when the degree of acetylation is greater than 4 mol % and less than 8 mol %, the degree of polymerization ranges from 1800 to 3200, and the hydroxyl group content is less than 26 mol %.

11. The polymer film of claim 1, wherein the polymer film is a three-layer structure consisting of an upper layer formed by a first said second layer, a lower layer formed by a second said second layer, and one said first layer sandwiched between the upper layer and the lower layer.

12. The polymer film of claim 11, wherein the polymer film is used as an intermediate film in laminated glass.

13. The polymer film of claim 12, wherein the loss factor of the polymer film is greater than 0.15 when measured at 10° C. according to ISO 16940: Measurement of the Mechanical Impedance of Laminated Glass on a 28^{th} day after completion of preparation of the polymer film.

14. The polymer film of claim 12, wherein the loss factor of the polymer film is greater than 0.25 when measured at 20° C. according to ISO 16940: Measurement of the Mechanical Impedance of Laminated Glass on a 28^{th} day after completion of preparation of the polymer film.

15. The polymer film of claim 12, wherein the loss factor of the polymer film is greater than 0.15 when measured at 30° C. according to ISO 16940: Measurement of the Mechanical Impedance of Laminated Glass on a 28^{th} day after completion of preparation of the polymer film.

16. The polymer film of claim 12, wherein the loss factor of the polymer film at 10° C. has a variation over time greater than 0%, the variation over time being calculated as:
(the loss factor of the polymer film measured on a 28^{th} day after completion of preparation of the polymer film−the loss factor of the polymer film measured on a first day after completion of the preparation of the polymer film)/the loss factor of the polymer film measured on the first day after completion of the preparation of the polymer film*100%;
wherein the loss factor is measured at 10° C. according to ISO 16940: Measurement of the Mechanical Impedance of Laminated Glass.

17. The polymer film of claim 12, wherein the loss factor of the polymer film at 20° C. has a variation over time greater than 0%, the variation over time being calculated as:
(the loss factor of the polymer film measured on a 28^{th} day after completion of preparation of the polymer film−the loss factor of the polymer film measured on a first day after completion of the preparation of the polymer film)/the loss factor of the polymer film measured on the first day after completion of the preparation of the polymer film*100%;
wherein the loss factor is measured at 20° C. according to ISO 16940: Measurement of the Mechanical Impedance of Laminated Glass.

18. The polymer film of claim 12, wherein the loss factor of the polymer film at 30° C. has a variation over time greater than −10%, the variation over time being calculated as:
(the loss factor of the polymer film measured on a 28^{th} day after completion of preparation of the polymer film−the loss factor of the polymer film measured on a first day after completion of the preparation of the polymer film)/the loss factor of the polymer film measured on the first day after completion of the preparation of the polymer film*100%;
wherein the loss factor is measured at 30° C. according to ISO 16940: Measurement of the Mechanical Impedance of Laminated Glass.

19. The polymer film of claim 12, wherein the polymer film has a thickness of 0.8 mm, with the upper layer having a thickness of 0.335 mm, the first layer having a thickness of 0.13 mm, and the lower layer having a thickness of 0.335 mm.
